(19) United States
(12) Patent Application Publication
(10) Pub. No.: US 2026/0224068 A1
(43) Pub. Date: Aug. 6, 2026

(54) POD LID WITH VAPOUR PASSAGE

(71) Applicant: BERGHOFF WORLDWIDE NV, Heusden-Zolder (BE)

(72) Inventor: Raf VANTHOOR, Heusden-Zolder (BE)

(21) Appl. No.: 19/152,268

(22) PCT Filed: Feb. 1, 2024
(86) PCT No.: PCT/IB2024/050920

§ 371 Date: Jul. 30, 2025

(30) Foreign Application Priority Data
Feb. 3, 2023 (BE) BE2023/0009
Apr. 28, 2023 (BE) BE2023/5343

(51) Int. Cl. A47J 36/38; A47J 36/06; A47J 45/06

(52) U.S. Cl. CPC A47J 36/38; A47J 36/06; A47J 45/063

(57) ABSTRACT

The present invention concerns a pot lid for a cooking pot, wherein the pot lid comprises a cover plate and a lid edge and is provided with a vapor passage, wherein the vapor passage makes a fluid connection between the pot volume and the ambient volume, wherein the vapor passage is formed by a vapor passage opening in the cover plate of the pot lid and a vapor removal channel, wherein the vapor removal channel extends to the lid edge for discharging vapor to the lid edge and wherein the vapor removal channel is surrounded by a housing. The present invention also concerns a cooking assembly comprising the aforementioned pot lid and a cooking pot.

### TECHNICAL FIELD

The present invention relates to pot lids for promoting vapor extraction, for removing cooking vapors. More specifically, the invention focuses on pot lids for supporting downdraft and/or sidedraft extraction systems.

### PRIOR ART

When heating food products at a cooking unit, an upwardly directed vapor stream is often created at the cooking unit. In order to suck in and carry away such vapor streams, an extraction system with vapor exhaust is typically provided near the cooking unit.

At a predetermined flow rate, updraft extraction systems (e.g. a traditional cooker hood) perform the best. Therein, the vapor exhaust is arranged above the cooking unit. However, significant disadvantages of such cooker hoods are their large size and their unattractive look. Moreover, they are part of the fixed kitchen infrastructure. A traditional cooker hood can thus not easily be stored away between two cooking sessions.

Amongst other things considering the above-mentioned disadvantages, downdraft and sidedraft extraction systems are becoming increasingly popular. The actual vapor exhaust is therein no longer provided above the cooking unit, but it can be concealed in the cooking unit itself, or it can be arranged along or behind the cooking unit.

However, often, such systems appear to be insufficiently powerful to extract the inherently upwardly directed vapor streams sideways/downwards. U.S. Pat. No. 5,279,279A tries to offer a solution to this, by means of a deflector plate that is arranged above the cooking unit. The curved surface of the deflector plate deflects the vapor stream in the direction of the vapor exhaust.

However, just like a cooker hood, such a deflector plate has a large size and an unattractive appearance. In addition, the deflector plate is part of the fixed kitchen infrastructure, which is again undesirable. It also appears to contribute only marginally to the downward/sideways discharge of vapor.

EP3723562 describes an assembly comprising a cooking pot and a corresponding pot lid for closing the cooking pot, wherein the assembly is provided with a vapor passage for conducting vapor away from the assembly. The assembly is capable of discharging the vapor in a downward direction, but the flow rate thereof cannot be regulated in EP3723562.

EP0916298 also describes an assembly comprising a cooking pot (in particular a pressure cooker or high-pressure cooker) and a corresponding pot lid. EP0916298 describes a mechanism to ensure user safety, where no pressure is created in the pot if it is not closed properly (safety closure) and where the pot can only be opened when there is no pressure (safety opening). However, EP0916298 does not describe a mechanism to remove the flow of vapor in a regulated manner.

The present invention now aims to find a solution for at least one of the above-mentioned problems or disadvantages.

### SUMMARY OF THE INVENTION

The invention concerns pot lids to promote vapor extraction, for removing cooking vapors.

In a first aspect, the invention concerns a pot lid according to claim 1. More specifically, the present invention concerns a pot lid for a cooking pot, wherein the pot lid comprises a cover plate and a lid edge and is provided with a vapor passage, wherein the vapor passage makes a fluid connection between the pot volume and the ambient volume, wherein the vapor passage is formed by a vapor passage opening in the cover plate of the pot lid and a vapor removal channel, wherein the vapor removal channel extends to the lid edge for discharging vapor to the lid edge and wherein the vapor removal channel is surrounded by a housing. In a preferred embodiment, the pot lid is further provided with a valve for regulating the flow rate of the vapor passage through the vapor removal channel. Preferred embodiments are shown in claims 2-14. In one embodiment, the vapor removal channel is raised above the surface of the cover plate. In another embodiment, the vapor removal channel is located on the underside of the cover plate.

The pot lid according to the present invention therefore makes it possible to discharge vapor in a regulated manner, by controlling the direction and possibly also the flow rate of the vapor passage.

In a second aspect, the invention concerns a cooking assembly comprising the aforementioned pot lid and a cooking pot.

### DESCRIPTION OF THE FIGURES

FIGS. 1 and 2 show a perspective side view of a pot lid according to an embodiment of the present invention wherein the pot lid is provided with a vapor removal channel that is raised above the surface of the cover plate for the controlled removal of the vapor passage and a valve for regulating the flow rate of the vapor passage. In FIG. 1, the valve is in a fully open configuration and the vapor is discharged sideways, starting from the center of the pot lid to the lid edge. In FIG. 2, the closing wall of the valve is located completely or partially in front of the proximal opening of the vapor removal channel and the vapor will not be able to move, or to a lesser extent, between the pot volume and the ambient volume.

FIGS. 3 and 4 show a perspective top view of a cooking assembly comprising a pot lid and a cooking pot according to an embodiment of the present invention. In FIG. 3, the valve is in a fully open configuration and the vapor is discharged sideways, starting from the center of the pot lid to the lid edge. In FIG. 4, the valve is in a partially open configuration. This still creates a vapor passage, but the flow rate is lower than when the valve is in a fully open configuration.

FIG. 5 shows a perspective bottom view of a pot lid according to an embodiment of the present invention.

FIG. 6 shows a perspective side view of a pot lid according to an embodiment of the present invention wherein the valve comprises an extension piece and the cap a hinge piece.

FIGS. 7 and 8 show a cross-section of a side view of a pot lid according to an embodiment of the present invention wherein the valve comprises an extension piece and the cap a hinge piece. In FIG. 7, the valve is in a fully open configuration creating a vapor passage. In FIG. 8, the valve is in a fully closed configuration, obstructing vapor passage.

FIG. 9 shows a bottom view of a pot lid according to an embodiment of the present invention wherein the valve comprises an extension piece and the cap a hinge piece with openings.

FIG. 10 shows a bottom view of the valve, the hinge piece of the cap and the housing of the vapor removal channel of a pot lid according to an embodiment of the present invention in a fully open (A), a half-open (B), and a closed (C) configuration.

FIG. 11 shows a bottom view of a pot lid according to an embodiment of the present invention wherein the valve is in an open configuration.

FIGS. 12 and 13 show a front view of a pot lid according to an embodiment of the present invention wherein the valve is in a half-open configuration.

FIG. 14 shows a top view of a pot lid according to an embodiment of the present invention with the valve removed and with the hinge piece with openings visible.

FIG. 15 shows a bottom view of a pot lid according to an embodiment of the present invention with the hinge piece with openings visible.

FIG. 16 shows a perspective side view of a cooking assembly according to an embodiment of the present invention wherein the vapor removal channel is located on the underside of the cover plate of the pot lid and the distal opening (the exit) of which is integrated into the lid edge.

FIG. 17 shows a perspective side view of a pot lid according to an embodiment of the present invention wherein the vapor removal channel is located on the underside of the cover plate of the pot lid and the distal opening (the exit) of which is integrated into the lid edge.

FIG. 18 shows a perspective side view of an upside down pot lid according to an embodiment of the present invention wherein the vapor removal channel is located on the underside of the cover plate of the pot lid.

FIGS. 19 and 20 show a cooking assembly 19 according to an embodiment of the present invention wherein the vapor removal channel 9 is located on the underside of the cover plate 3 of the pot lid 1.

### DETAILED DESCRIPTION

The invention concerns a pot lid comprising a vapor passage. The pot lid according to the present invention makes it possible to discharge cooking vapor in a regulated manner, by controlling the direction on the one hand and the flow rate of the vapor passage on the other.

Unless otherwise defined, all terms used in the description of the invention, including technical and scientific terms, have the meanings as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

When the term “around” or “about” is used in this document with a measurable quantity, a parameter, a duration or moment, and the like, then variations are meant of approx. 20% or less, preferably approx. 10% or less, more preferably approx. 5% or less, even more preferably approx. 1% or less, and even more preferably approx. 0.1% or less than and of the quoted value, insofar as such variations are applicable in the described invention. However, this must be understood to mean that the value of the magnitude where the term “approximately” or “around” is used, is itself specifically disclosed.

The terms “comprise,” “comprising,” “consist of,” “consisting of,” “provided with,” “have,” “having,” “include,” “including,” “contain,” “containing” are synonyms and are inclusive or open terms that indicate the presence of what follows, and which do not exclude or prevent the presence of other components, characteristics, elements, members, steps, as known from or disclosed in the prior art.

Quoting numeric intervals by the endpoints includes all integers, fractions, and/or real numbers between the endpoints, including those endpoints.

The terms “vapor(s)” and “cooking effluent(s)”, as used throughout this document, are interchangeable terms and should be interpreted very broadly. Among other things, they can indicate any cooking effluent, selected from the group comprising water vapor, fat vapor, oil vapor and other vapors and gases, steam, smoke, warm air, fine water droplets, fat droplets and/or oil droplets in gas/vapor, other misty substances, powdery substances in gas/vapor and any mixture thereof. In a further or alternative definition, “vapor(s)” and “cooking effluent(s)” relate to any substantially gaseous mixture that is released when preparing/processing food products (or more in general in an operative state of the assembly), and for which it is desirable that they are extracted by means of vapor extraction. Such vapors can be released when heating food products, but the invention is by no means limited thereto.

The terms “vapor extraction” and “extraction system” are interchangeable terms and indicate systems for the extraction of vapors during the preparation/processing of food products (e.g., by heating), thus encompassing updraft (e.g., the traditional cooker hood), downdraft and sidedraft extraction systems. Where desirable, it will be further specified whether it concerns an updraft, downdraft, or sidedraft extraction system. If not further specified, the term “downdraft extraction system” will refer to extraction systems in downward and/or sideways directions, by analogy with the English term “downdraft/downdraught systems”.

Furthermore, the invention is by no means limited to either cooking or baking. “Cooking”, as used throughout this document, shall be understood to include boiling, baking, frying, grilling, roasting, poaching, stir-frying, braising, steaming, stewing and any other technique for preparing food, which could release vapors/cooking effluents. Moreover, when referring to a “cooking pot,” the latter term may be substituted for “frying pan,” “deep frying pan,” “casserole,” “stir fry pan,” “steamer” and the like. Preferably, the cooking pot comprises a “pot bottom” and a “pot wall”, which pot wall extends from the pot bottom in an upward direction up to an open circumferential edge of the cooking pot, also called the “pot edge”. Said open circumferential edge thereby surrounds an upward-directed pot opening. Incidentally, “edge” and “edge part” are used herein as interchangeable terms. Preferably, the cooking pot is suitable for placement thereof on a cooking unit comprising at least one cooktop (e.g., an electric cooktop, a gas cooktop or an induction cooktop), for heating the contents of the cooking pot from the bottom of the pot. In a possible embodiment, the pot bottom is substantially a circular disk, wherein the pot wall is substantially a circular tube, and wherein the pot edge also substantially describes a circle. In another, possible embodiment, the pot bottom is substantially an oval disk, wherein the pot wall is substantially an oval tube, and wherein the pot edge also substantially describes an oval. Of course, the invention is not limited to circular/oval cooking pots; a person skilled in the art is able to apply the invention to and/or in combination with a cooking pot of any design known in the art.

The terms “lid(s)” and “pot lid(s)”, as used throughout this document, are interchangeable terms. They refer to lids for closing off pot openings of cooking pots, as known in the art. Typically, the pot lid defines a lid edge that can be placed at least partially in, on or over the pot edge, wherein the cooking pot and the corresponding pot lid are brought into a closed configuration. In this closed configuration, the lid edge preferably rests on the pot edge, and they define an (at least partially) closed “pot volume”, extending inside the cooking pot and the pot lid. The pot volume is suitable for enclosing food during its processing (e.g., by heating). An “ambient volume” extends beyond that.

“Food products” should be understood very broadly, as possibly including any substance(s), suitable for processing (e.g., heating) thereof within a pot volume, and suitable for consumption thereof after processing within a pot volume.

The term “vapor passage,” as used throughout this document, refers in its broadest sense to a path that vapor can follow. The presence of a vapor passage is therefore not necessarily expressed in the presence of something material/tangible, but rather in at least the existence of the possibility of the passage of vapor. However, a (tangible) object/element/body and the like that “comprises a vapor passage”, is of such a shape that vapor has the ability to pass, for example, along or through that object. The corresponding vapor passage then refers to the path that is thereby followed by the vapor. Optionally, this vapor passage can be partly determined by, among other things, the vapor pressure, vapor pressure gradient and vapor temperature.

When “bending/deflecting the vapor passage”, the vapor is forced into a bend; the followed path thereby comprises at least one bend.

The term “vapor permeability”, as used throughout this document, is the extent to which a material resists the transport of (water) vapor as a result of air pressure differences. Materials are typically classified into 3 vapor permeability classes. Only a few materials are completely “vapor-tight” (e.g., glass and aluminum). All the other materials are vapor retardant or vapor-permeable. The degree of vapor permeability for a material is expressed by a certain μ value; for a product with a certain thickness, the vapor permeability is expressed by an Sd value (also called μd value). The biggest difference with air-tightness is that vapor transports through a material (=vapor diffusion) and not (solely) through any discontinuities in the material.

In a first aspect, the invention concerns a pot lid for a cooking pot, wherein the pot lid is provided with a vapor passage. The pot lid comprises a cover plate and a lid edge and in a closed configuration, the lid edge of the pot lid rests on the pot edge of the cooking pot, and they define an (at least partially) closed “pot volume”, extending inside the cooking pot and the pot lid. The pot volume is suitable for enclosing food during its processing (e.g., by heating). An “ambient volume” extends beyond that. The vapor passage in the pot lid of the present invention makes a fluid connection between the pot volume and the ambient volume. In the pot lid of the present invention, this vapor passage is formed by a vapor passage opening in the cover plate of the pot lid and a vapor removal channel.

The vapor removal channel extends to the lid edge, making it suitable for removing vapor from the pot volume to the ambient volume. The pot lid according to the present invention thus makes it possible to discharge cooking vapor in a regulated manner by controlling the direction of the vapor passage. In one embodiment, the vapor removal channel is raised above the surface of the cover plate. In another embodiment, the vapor removal channel is located on the underside of the cover plate. In one embodiment, the distal end of the vapor removal channel (the exit) is integrated into the lid edge. The vapor removal channel is surrounded by a housing. In one embodiment, the housing of the vapor removal channel is attached to the cover plate (the top or the bottom) by means of a silicone intermediate layer. This silicone intermediate layer can assume different proportions and can, for example, extend over the entire surface of the underside of the vapor removal channel housing or can cover only part of this surface.

The designation “to the lid edge” may be broadly interpreted here. In one embodiment, the vapor removal channel extends to the most peripheral point of the pot lid/lid edge (measured from the center of the pot lid). In one embodiment, the vapor removal channel extends beyond the most peripheral point of the pot lid. In one embodiment, the vapor removal channel is 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24% or 25% longer than the radius of the pot lid. In one embodiment, the vapor removal channel is more than 25% longer than the radius of the pot lid. In one embodiment, the vapor removal channel does not extend beyond the most peripheral point of the pot lid but is shorter. In one embodiment, the vapor removal channel is 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24% or 25% shorter than the radius of the pot lid. In one embodiment, the vapor removal channel is more than 25% shorter than the radius of the pot lid.

The pot lid is therefore provided with a vapor passage for conducting vapor away from the pot volume. Thus, the pot lid, when placed on a corresponding cooking pot, still allows vapor to be released from the pot volume.

In a preferred embodiment, the vapor passage is further formed by a cap (a cover) with an opening, wherein the cap is located on the underside of the cover plate and at the vapor passage opening. By providing such a cap with an opening, the vapor can be better channeled through the vapor passage opening. It is important that the cap fits firmly on the vapor removal channel (and thus makes a completely vapor-tight connection therewith). In this way, a vapor passage is created between the pot volume and the ambient volume, starting from the opening in the cap on the underside of the cover plate and extending to the distal end of the vapor removal channel. In a further embodiment, the cap is a screw cap that is screwed into the housing of the vapor removal channel. In a further embodiment, the cap further comprises a hinge piece for screwing the cap on. By providing a cap that can screw onto a hinge piece connected to the valve, the assembly can be screwed down securely so as not to allow any openings for vapor loss. The assembly can also be unscrewed and dismantled again. This has the advantage that the various parts can be cleaned optimally and that no dirt or food remains can accumulate anywhere. In a preferred embodiment, the bottom plane of the hinge piece is not completely open, but the bottom surface of the hinge piece comprises a closed side provided with one or more openings. In one embodiment, the hinge piece is attached to the extension piece of the valve (see below) by means of a bayonet coupling. In this case, two objects (the hinge piece and the extension piece) are attached to each other by inserting the (spring-loaded) pins or projections on the one object (in this case the hinge piece) into the special slots in the other object (in this case the extension piece) and then rotating both objects through a limited angle and thus fixing them. In an alternative embodiment, the hinge piece is attached to the extension piece of the valve by means of a screw thread.

Moreover, a pot lid with sufficiently large vapor passage(s) allow to cook freely in the environment (at atmospheric pressure), with the use of a closed cooking pot. The vapor is then led away from the pot volume along the aforementioned vapor passage(s), while the pot lid shields the user from water, oil, and the like splashing upwards. The heat is also retained better in the cooking pot. In a traditional cooking assembly (pot lid and cooking pot), the pot lid must be placed crookedly (and often in a very unstable manner) on the edge of the cooking pot (the pot edge). Moreover, the size of the vapor passage between lid edge and pot edge can thereby not be adjusted precisely, and the pot lid no longer offers a full protection against water, oil, and the like splashing upwards. According to the present invention, the extent to which vapor can leave the pot volume is therefore determined by a mechanism capable of regulating the flow rate of the vapor passage.

The pot lid of the present invention is namely preferably provided with a valve for regulating the flow rate of the vapor passage through the vapor removal channel. The vapor removal channel namely forms a channel bounded by an opening at the proximal end (on the side of the vapor passage opening) and an opening at the distal end (on the side of the lid edge). In a preferred embodiment, the valve comprises a rotary knob and it is rotatably connected to the housing of the vapor removal channel. In one embodiment, this valve is positioned such that, in an open configuration, it allows a vapor passage between the pot volume and the vapor removal channel, thus releasing vapor from the pot volume via the vapor removal channel. In a closed configuration of the valve, it completely seals the opening at the proximal end of the vapor removal channel, thereby preventing any vapor from being released from the pot volume. In the present invention it is important that the connection between the valve and the housing of the vapor removal channel is as vapor-tight as possible, in order to avoid unwanted vapor passage at the aforementioned connection and thus to discharge the vapor to the lid edge in a regulated manner. In a preferred embodiment, a sealing ring (such as a silicone ring) is located between the valve and the housing of the vapor removal channel.

In a preferred embodiment, the valve comprises a rotary knob, a push-button, an adjustment lever or lever and a closing wall, whereby the position of the closing wall is regulated by the rotary knob, push-button, adjustment lever or lever. In one embodiment, this valve (i.e. also the rotary knob, push-button, adjustment lever or lever) is centrally located with respect to the cover plate (in the middle). In another embodiment, this valve (i.e., also the rotary knob, push-button, adjustment lever or lever) is located more radially with respect to the cover plate. By rotating the closing wall (for example, by a sideways movement of a rotary knob) or moving it up and down (for example, by an up/down movement of a push-button), the valve can be in an open, partially open or closed configuration. When the valve is in a fully open configuration, the vapor is discharged unhindered through the vapor removal channel to the lid edge. When the valve is in a closed position, the vapor will not be able to move between the pot volume and the ambient volume. The valve may also be in a partially open configuration, in which a vapor passage is still created, but wherein the flow rate is lower than when the valve is in a fully open configuration.

In one embodiment, the valve further comprises an extension piece in line with the closing wall, wherein the closing wall is located at the opening at the proximal end of the vapor removal channel and wherein the extension piece is located under this opening, in line with the vapor passage opening. In one embodiment, the extension piece comprises one or more closable openings for further regulating the flow rate of the vapor passage through the vapor removal channel. In a further embodiment, these one or more closable openings are located on the underside of the extension piece and can be closed by the hinge piece of the cap. When these one or more openings of the extension piece are aligned with the one or more openings of the hinge piece, a vapor passage is created. When these one or more openings of the extension piece are partially aligned with the one or more openings of the hinge piece, a partial vapor passage is created. When these one or more openings of the extension piece are not aligned with the one or more openings of the hinge piece, the vapor passage is blocked. By regulating the valve (for example, by turning or pressing it), the flow rate will be regulated both by changing the position of the closing wall and of the one or more openings in the extension piece. This makes it possible to close the vapor passage (completely or partially) in two places, namely at the extension piece of the valve and at the proximal end of the vapor removal channel. These openings in the extension piece and the hinge piece can take any shape and size. In one embodiment, these openings are triangular in shape.

The vapor removal channel can take any shape and can, for example, take the shape of a hollow cylinder or a hollow beam.

It is important that the closing wall is capable of completely closing the opening at the proximal end of the vapor removal channel in the closed configuration of the valve. The closing wall will therefore always be at least as high as the height of the opening at the proximal end of the vapor removal channel.

In one embodiment, the closing wall has a height between 2 and 25 mm, preferably between 5 and 15 mm, such as 8 mm or 10 mm.

In a preferred embodiment, the closing wall comprises a partial cylindrical shell. In one embodiment, the closing wall comprises at least 30%, preferably at least 40%, such as 50% or 60% or 70% or 80%, of a complete cylindrical shell.

In one embodiment, the rotary knob, adjustment lever, push-button or lever is adjustable in discrete steps. In one embodiment, the rotary knob, adjustment lever, push-button or lever can be placed in three different configurations (closed, half open and open). In one embodiment, the valve comprises a projection that is configured to fit into the openings provided for this purpose in the housing of the vapor removal channel. In this way, the valve clicks into place on the housing of the vapor removal channel at specific fixed positions. In a further embodiment, the rotary knob, push-button, adjustment lever or lever is adjustable in discrete steps of 45 degrees each. When the valve is positioned such that the closing wall is completely level with the opening at the proximal end of the vapor removal channel, the vapor cannot pass and the vapor passage is blocked. At a certain angle of rotation of the valve (in the case of a rotary knob), the closing wall is no longer at the level of the opening at the proximal end of the vapor removal channel and the vapor can pass through. At a certain angle of rotation of the valve (in the case of a rotary knob), the closing wall partially closes the opening at the proximal end of the vapor removal channel and the vapor can partially pass through. With a push-button, an up and down movement of the closing wall will regulate the flow rate.

In another embodiment, the rotary knob, push-button, adjustment lever or lever is adjustable in a continuous manner, i.e. without discrete steps. In such an embodiment, the flow rate of the vapor passage through the vapor removal channel can be regulated in a continuous manner.

In one embodiment, the distal end of the vapor removal channel also extends in a sideways direction. In this way, the vapor removal channel directs the vapor passage in line with the horizontal (or almost horizontal) plane where the pot lid is located and the vapor stream along the entire length of the path followed has a (largely) lateral displacement component. This assumes a closed configuration of cooking pot and pot lid, with the pot lid placed on top of the cooking pot. In such an embodiment, the vapor stream is ejected in a largely lateral direction, from the pot volume, into the ambient volume. Such an assembly contributes to vapor extraction by means of a downdraft and/or sidedraft extraction system.

In one embodiment, the distal end of the vapor removal channel extends in a downward direction to direct the vapor passage toward the cooking pot. This assumes a closed configuration of cooking pot and pot lid, with the pot lid placed on top of the cooking pot. The vapor passage ultimately extends in the direction of the cooking pot, in the sense that along at least part of the path followed, the vapor stream has a downward displacement component. In such an embodiment, the vapor stream is ejected in a downward direction, from the pot volume, into the ambient volume. Such an assembly contributes to vapor extraction by means of a downdraft and/or sidedraft extraction system. In one embodiment, part of the vapor passage runs substantially parallel to the outer surface of the pot wall. The vapor stream can therefore easily be guided downwards or sideways, along (at least part of) the wall structure of the cooking pot. This wall structure therefore acquires an additional function. In such an embodiment the vapor is thus guided in a downward direction, along a vertical and/or inclined part of the wall structure. For example, the wall stream moves along the pot wall to a vapor exhaust located next to or around the cooktop, where the vapor is sucked in.

It has namely been found that the discharge of a vapor stream in a downward or sideways direction is therein much more effective than means for deflecting an originally upwardly directed vapor stream in a downward or sideways direction, for example by means of a deflector plate. Namely, the vapor stream remains better converged, which means it will retain its direction better. Moreover, such an assembly can be easily stored between two cooking sessions, as is common for cooking pots and pot lids.

Under the right conditions of temperature, pressure, pressure drop and flow rate, such a vapor stream is effectively drawn to that outer surface, whereby it follows the shape of that outer surface (the so-called Coanda effect). Such a design for the vapor assembly therefore not only allows the apparently inherently upwardly directed vapor stream to be directed downwards, but also to better preserve the further, downward displacement component of that vapor stream. The downdraft extraction system is thereby further supported.

Because the extraction system is supported, it can also be made lighter, so that the production and installation costs will also be lower. As an alternative, an extraction system is provided with two or more modes: in a first mode of low suction flow, cooking can only be done using the above-mentioned assembly, or at least in a configuration wherein the downdraft extraction system is sufficiently supported. In addition, when cooking using traditional assemblies, or in a cooking pot without a lid, the extraction system is switched to a second mode with high suction flow.

It is a known problem of sidedraft and/or downdraft extraction systems that they often do not perform sufficiently well. After all, warm vapor tends to rise in homogeneous ambient air at room temperature (Archimedes' law). The extraction system must therefore be more powerful than if it were an updraft extraction system: on the one hand for deflecting and suctioning a rising vapor stream, and on the other hand for actually sucking in that vapor stream. The present invention aims to solve this problem.

The pot lid according to the present invention can comprise stainless steel, (cast) aluminum, glass, borosilicate, porcelain, silicone, and any other material, as well as combinations thereof, as known in the art. The cooking pot according to the present invention can comprise stainless steel, (cast) aluminum, glass, borosilicate, porcelain, silicone, and any other material, as well as combinations thereof, as known in the art. In a preferred embodiment, the cover plate is made of glass or metal (for example stainless steel (SS)). In a preferred embodiment, the lid edge comprises silicone. In a preferred embodiment, the housing of the vapor removal channel, the valve and the cap are made of plastic.

According to a possible embodiment, the pot lid connects to the cooking pot by means of a rubber clamp, whereby the lid edge and/or pot edge comprise silicone. This ensures a good mutual connection, so that all vapor can escape via the vapor passage in a directed way.

According to a further or alternative embodiment, the pot lid is concave. Condensation will therein drain along the inside of the pot lid towards the central axis; this is to prevent too much condensation from escaping from the pot volume along the vapor removal channel (on the edge of the pot lid).

According to a further or alternative embodiment, the pot lid comprises two handles, which handles extend diametrically, and wherein the vapor removal channel extends along a transverse direction, transverse to the diametrical direction of the handles. Such a design takes into account safety, in particular the risk of burning. Indeed, the handles are as far away from the vapor passage as possible.

In a second aspect, the invention concerns a cooking assembly comprising a pot lid as described above and a cooking pot.

In what follows, the invention is described by way of non-limiting examples illustrating the invention, and which are not intended to and should not be interpreted as limiting the scope of the invention.

### DESCRIPTION OF THE FIGURES

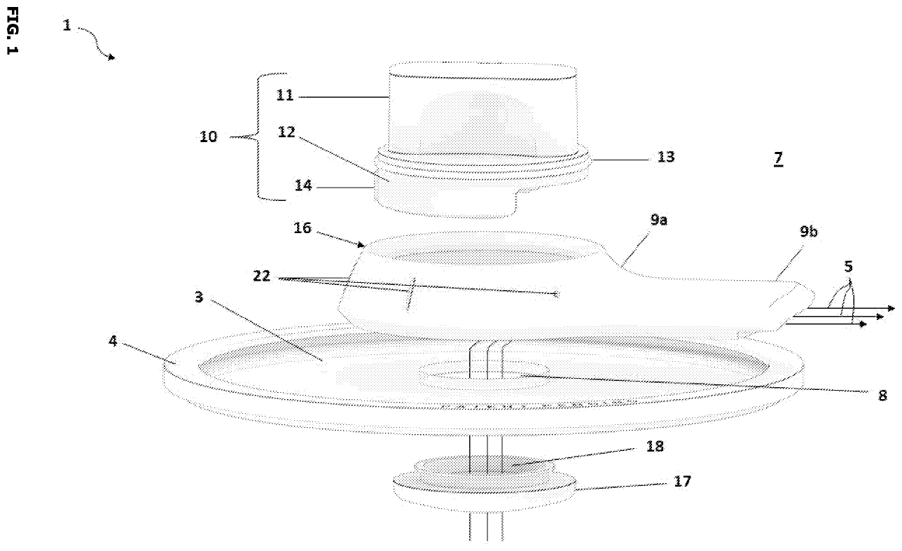

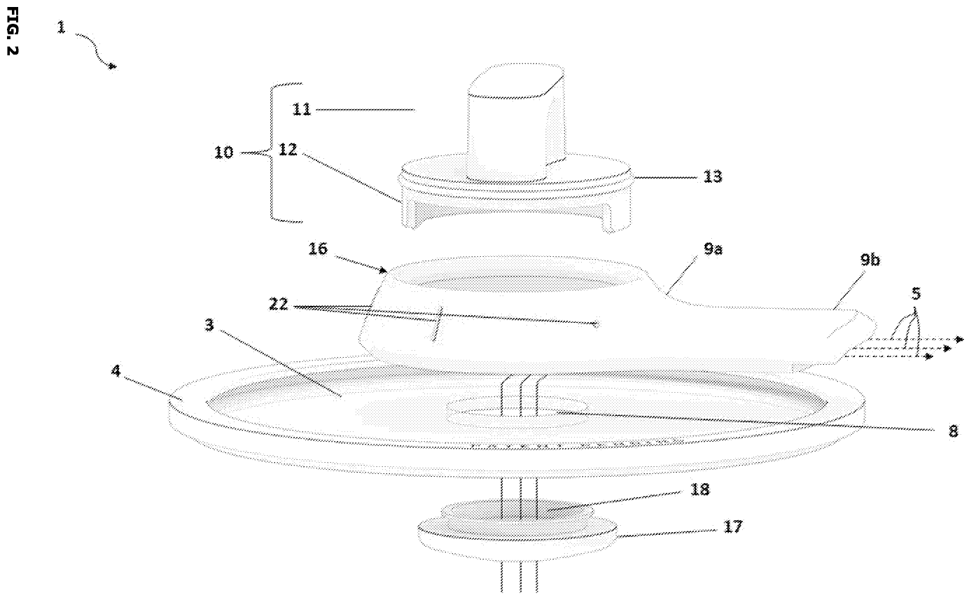

FIGS. 1 and 2 show a perspective side view of a pot lid 1 according to an embodiment of the present invention. The pot lid 1 comprises a cover plate 3 made of glass and a lid edge 4 comprising a silicone rim for a good connection to the cooking pot (not shown). In closed configuration, the lid edge 4 of the pot lid 1 rests on the pot edge of the cooking pot, and they define an (at least partially) closed “pot volume”, extending inside the cooking pot and the pot lid 1. The pot volume is suitable for enclosing food during its processing (e.g., by heating). An “ambient volume” 7 extends outside of it. The pot lid 1 is provided with a vapor passage 5, wherein the vapor passage 5 makes a fluid connection between the pot volume and the ambient volume 7 and is therefore able to conduct vapor away from the pot volume in a controlled manner. Thus, the pot lid 1, when placed on a corresponding cooking pot, still allows vapor to be released from the pot volume. Moreover, a pot lid 1 with sufficiently large vapor passage(s) 5 allow to cook freely in the environment (at atmospheric pressure), with the use of a closed cooking pot. The vapor is then led away from the pot volume along the aforementioned vapor passage(s) 5, while the pot lid 1 shields the user from water, oil, and the like splashing upwards. The heat is also retained better in the cooking pot. In a traditional cooking assembly (pot lid and cooking pot), the pot lid must be placed crookedly (and often in a very unstable manner) on the edge of the cooking pot (the pot edge). Moreover, the size of the vapor passage between lid edge and pot edge can thereby not be adjusted precisely, and the pot lid no longer offers a full protection against water, oil, and the like splashing upwards. The vapor passage 5 in FIG. 1 is formed by an opening 18 in a cap (a cover) 17 (wherein the cap is placed on the underside of the cover plate 3 and at the vapor passage opening 8) and a vapor removal channel 9. By providing such a cap 17 with an opening 18, the vapor can be better channeled through the vapor passage opening 8. It is important that the cap 17 fits firmly on the vapor removal channel 9 (and thus makes a preferably completely vapor-tight connection therewith). In this way, a vapor passage 5 is created between the pot volume and the ambient volume 7, starting from the opening 18 in the cap 17 on the underside of the cover plate 3 and extending to the distal end of the vapor removal channel 9b. The cap 17 is a screw cap that is screwed into the housing of the vapor removal channel 16. In FIGS. 1-2, the vapor passage opening 8 is located centrally in the cover plate 3 of the pot lid 1. The vapor removal channel 9 extends from the vapor passage opening 8 to the lid edge 4 and thus discharges the vapor towards the lid edge 4. The vapor removal channel 9 is raised above the surface of the cover plate 3 and is surrounded by a housing 16. According to the present invention, the extent to which vapor can leave the pot volume is determined by a valve capable of regulating the flow rate of the vapor passage 5 through the vapor removal channel 9. The pot lid 1 is namely provided with a valve 10 with a closing wall 12, wherein the position of the closing wall is regulated by a rotary knob 11. In FIGS. 1-2, the closing wall 12 comprises a partial cylindrical shell, wherein the closing wall has a height of 10 mm. By rotating the closing wall 12 by means of the rotary knob 11, the valve 10 can be in an open, partially open or a closed configuration. In FIGS. 1-2, the rotary knob 11 is adjustable in discrete steps. To this end, the valve comprises a projection 14 that is configured to fit into the openings provided for this purpose in the housing of the vapor removal channel (not visible). In this way, the valve clicks into place on the housing of the vapor removal channel at specific fixed positions. These positions are shown on the outside of the housing 16 by markings 22. When the valve 10 is in a fully open configuration (FIG. 1), the vapor is discharged unhindered from the pot volume through the opening in the cap (through the vapor passage opening) and through the vapor removal channel 9 (on top of the cover plate 3) to the lid edge 4. In FIG. 2, the closing wall of the valve is located completely or partially in front of the proximal opening of the vapor removal channel and the vapor will not be able to move, or to a lesser extent, between the pot volume and the ambient volume (shown by dotted lines in FIG. 2). When the valve 10 is in a closed position by turning the rotary knob, the vapor will not be able to move between the pot volume and the ambient volume 7. The valve 10 may also be in a partially open configuration, whereby a vapor passage 5 is still created, but wherein the flow rate is lower than when the valve 10 is in a fully open configuration. Updraft extraction systems (e.g., a traditional cooker hood), where the vapor exhaust is installed above the cooking unit, have as major disadvantages their large size and their unattractive appearance. Moreover, they are part of the fixed kitchen infrastructure. A traditional cooker hood can thus not easily be stored away between two cooking sessions. The pot lid of the present invention makes it possible to discharge vapor in a regulated manner. In FIGS. 1 and 2, the vapor is namely discharged sideways to the lid edge and not upwards. In addition, the pot lid of the present invention makes it possible to regulate the flow rate of the vapor passage by means of a valve. The pot lid of the present invention is thus capable of supporting a downward or sideways extraction system. Because the extraction system is supported, it can also be made lighter, so that the production and installation costs will also be lower.

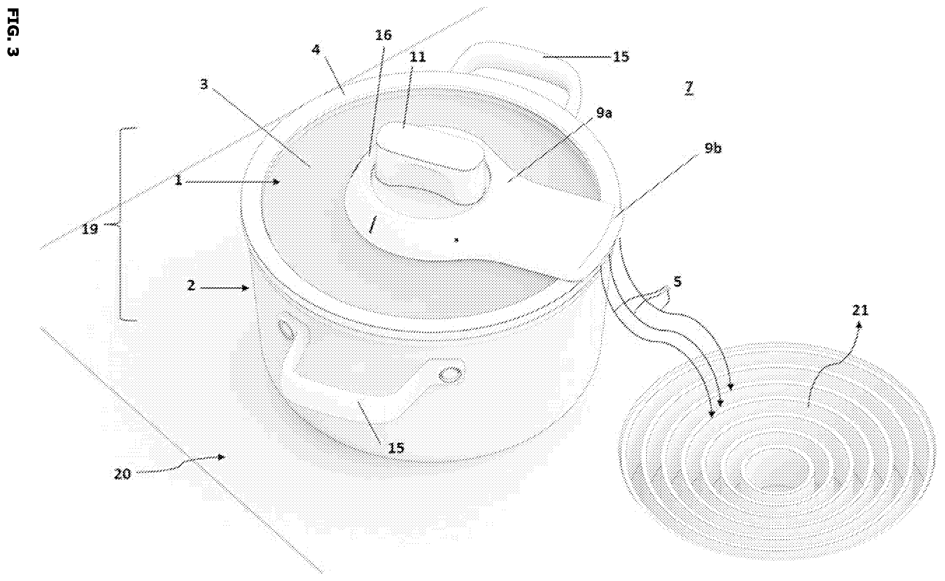

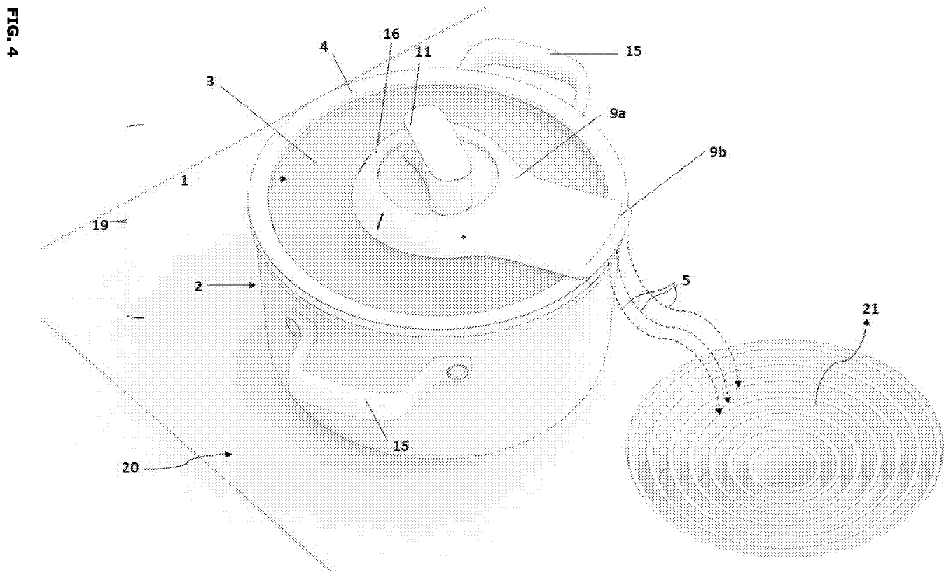

FIGS. 3 and 4 show a perspective top view of a cooking assembly 19 comprising a pot lid 1 and a cooking pot 2 according to an embodiment of the present invention. The cooking assembly 19 is positioned on a cooking unit 20 that is provided with a vapor exhaust 21. The pot lid 1 comprises a cover plate 3 made of glass and a lid edge 4 comprising a silicone rim for a good connection to the cooking pot 2. An “ambient volume” 7 extends outside the pot volume. The pot lid 1 is provided with a vapor passage 5, wherein the vapor passage 5 makes a fluid connection between the pot volume and the ambient volume 7 and is therefore able to conduct vapor away from the pot volume in a controlled manner. The vapor removal channel 9 extends to the lid edge 4 and thus discharges the vapor to the lid edge 4. The vapor removal channel 9 is raised above the surface of the cover plate 3 and is surrounded by a housing 16. According to the present invention, the extent to which vapor can leave the pot volume is determined by a valve 10 capable of regulating the flow rate of the vapor passage 5 through the vapor removal channel 9. The pot lid 1 is namely provided with a valve 10 with a closing wall (not visible), wherein the position of the closing wall is regulated by a rotary knob 11. By rotating the closing wall by means of the rotary knob 11, the valve 10 can be in an open, partially open or a closed configuration. In FIGS. 3-4, the rotary knob 11 is adjustable in discrete steps. When the valve 10 is in a fully open configuration (FIG. 3), the vapor is discharged unhindered (the vapor passage 5 is unhindered, shown by solid lines) from the pot volume through the vapor removal channel 9 to the lid edge 4. When the valve 10 is in a closed position by turning the rotary knob, the vapor will not be able to move between the pot volume and the ambient volume 7. The valve 10 can also be in a partially open configuration (e.g., by turning the rotary knob 45 degrees, see FIG. 4), whereby a vapor passage 5 is still created, but wherein the flow rate is lower than when the valve 10 is in a fully open configuration (shown by the dotted lines in FIG. 4). The pot lid in FIGS. 3 and 4 has two handles 15, which handles 15 extend diametrically, and wherein the vapor removal channel 9 extends along a transverse direction, transverse to the diametrical direction of the handles. Such a design takes into account safety, in particular the risk of burning. Indeed, the handles are as far away from the vapor passage 5 as possible. As described above, the pot lid of the present invention makes it possible to discharge vapor laterally and/or downwards in a controlled manner and to regulate the flow rate of the vapor passage by means of a valve. The pot lid of the present invention is thus capable of supporting a downward or sideways extraction system.

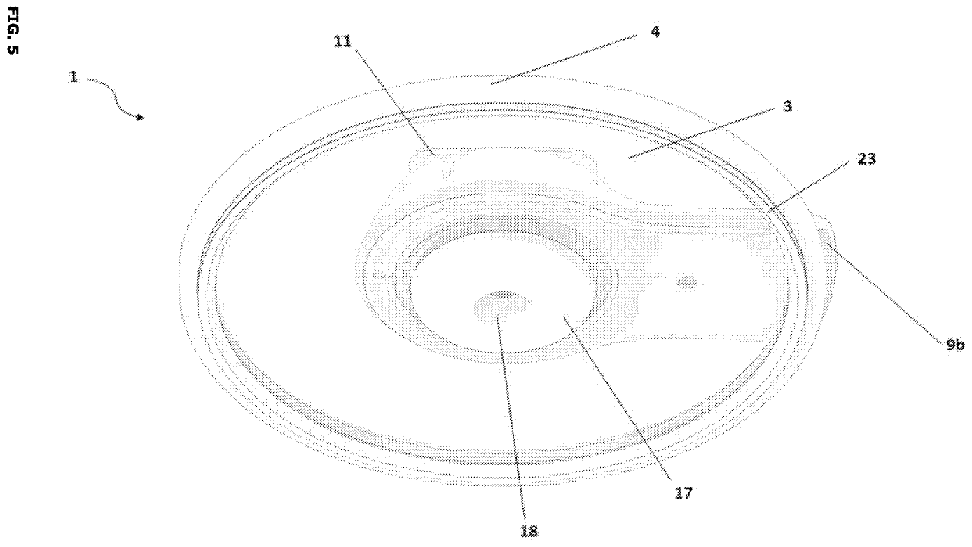

FIG. 5 shows a perspective bottom view of a pot lid 1 according to an embodiment of the present invention. The pot lid 1 comprises a cover plate 3 and a lid edge 4 comprising a silicone rim 23 for a good connection to the cooking pot (not shown). The opening 18 in the cap (a cover) 17 on the underside of the cover plate 3 and at the vapor passage opening is clearly visible. By providing such a cap 17 with an opening 18, the vapor can be better channeled through the vapor passage opening. It is important that the cap 17 fits firmly on the vapor channel 9 (and thus makes a completely vapor-tight connection therewith). In this way, a vapor passage 5 is created between the pot volume and the ambient volume, starting from the opening 18 in the cap 17 on the underside of the cover plate 3 and extending to the distal end of the vapor removal channel 9b. The cap 17 is a screw cap that is screwed into the housing of the vapor removal channel. According to the present invention, the extent to which vapor can leave the pot volume is determined by a valve capable of regulating the flow rate of the vapor passage through the vapor removal channel. The pot lid 1 is namely provided with a valve 10 with a closing wall (not visible), wherein the position of the closing wall is regulated by a rotary knob 11.

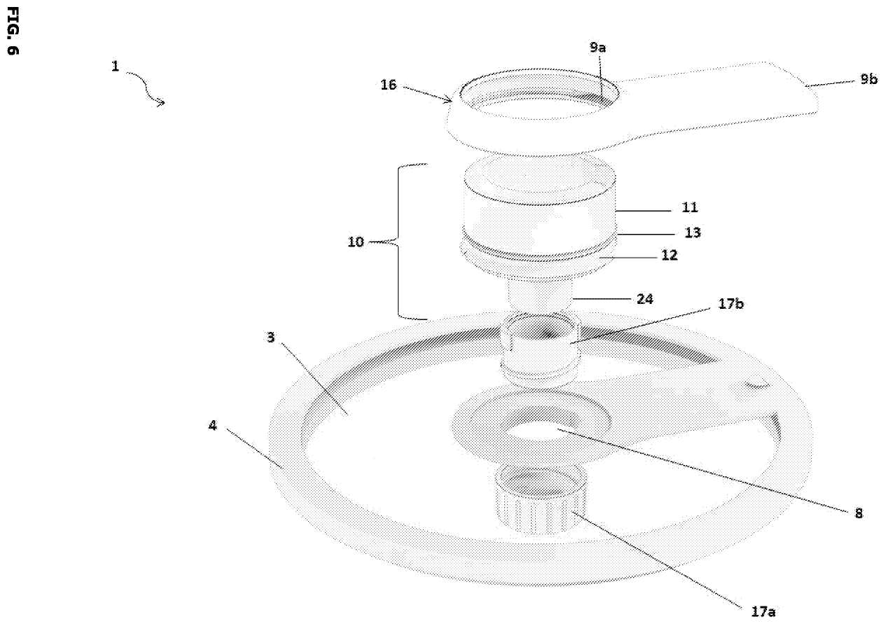

FIG. 6 shows a perspective side view of a pot lid 1 according to an embodiment of the present invention wherein the valve 10 comprises an additional extension piece 24. The cap 17a also comprises an additional hinge piece 17b. The extension piece 24 is part of the valve and is located under the closing wall 12, wherein the closing wall 12 is located at the level of the opening at the proximal end 9a of the vapor removal channel and wherein the extension piece 24 is located under this opening, in line with the vapor passage opening 8, under the plane of the cover plate. The hinge piece 17b clicks into place on the extension piece 24 of the valve at the level of the vapor passage opening 8 by means of a bayonet coupling and is provided with a screw thread onto which the cap 17a can be screwed. The cap 17a has an opening 18 on the underside and thus allows free passage of vapor. The extension piece 24 is provided with two openings (not visible) on the underside, which, when aligned with the openings in the underside of the hinge piece 17b, allows a vapor passage 5 between the pot volume and the ambient volume, starting from the opening 18 in the cap 17a on the underside of the cover plate 3 and extending to the distal end of the vapor removal channel 9b.

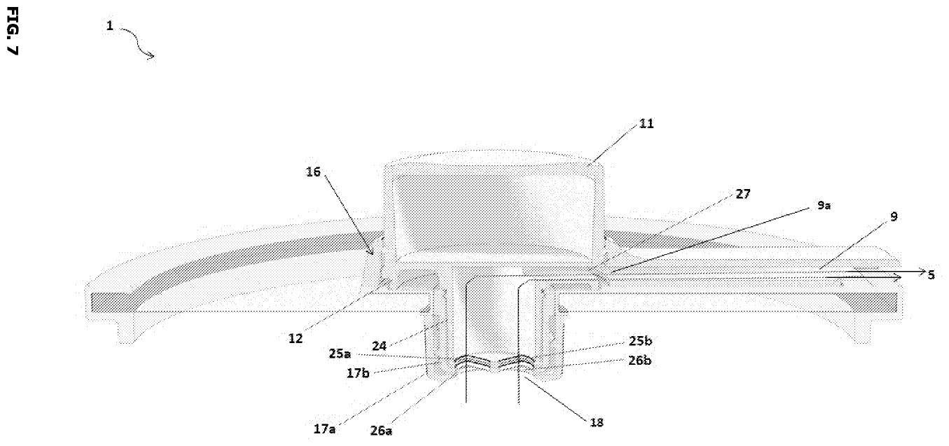

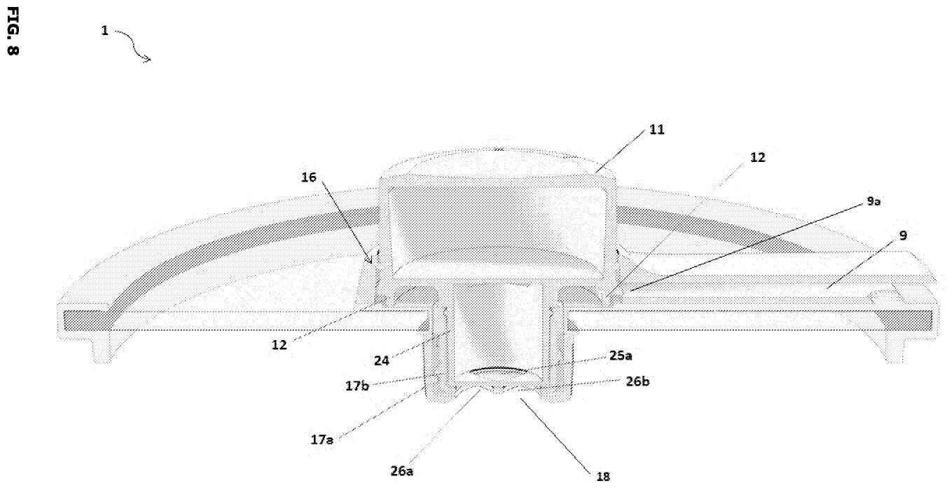

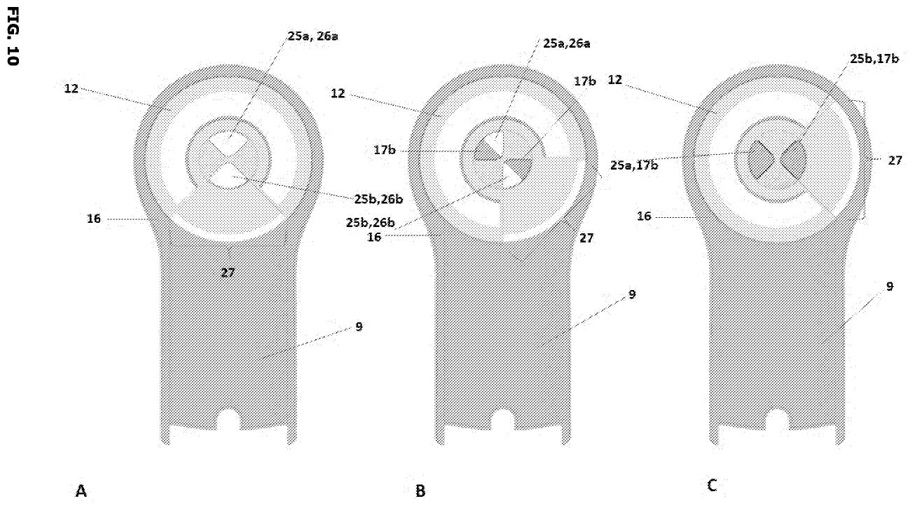

FIGS. 7 and 8 show a cross-section of a side view of a pot lid according to an embodiment of the present invention wherein the valve comprises an extension piece and the cap a hinge piece. In FIG. 7, the valve is in a fully open configuration creating a vapor passage 5 between the pot volume and the ambient volume. The extension piece 24 namely comprises two closable openings 25a, 25b for further regulating the flow rate of the vapor passage 5 through the vapor removal channel 9. The closable openings 25a, 25b are located on the underside of the extension piece 24 and can be closed by the hinge piece 17b of the cap. Namely, when these openings 25a, 25b of the extension piece 24 are aligned with the openings of the hinge piece 26a, 26b, a vapor passage 5 is created (see also FIG. 10A). When these openings of the extension piece are partially aligned with the openings of the hinge piece, a partial vapor passage is created (see FIG. 10B). When these openings of the extension piece are not aligned with the openings of the hinge piece, the vapor passage is blocked (see FIG. 10C). By regulating the valve 10 (for example by turning or pressing it), the flow rate will be regulated both by changing the position of the closing wall 12 and the openings in the extension piece. In FIG. 7, the vapor can move via the opening 18 in the cap 17a, via the aligned openings 26a, 26b in the hinge piece 17b and the openings 25a, 25b in the extension piece 24, through the opening 27 in the closing wall 12, through the vapor removal channel 9 in the direction the ambient volume. In FIG. 8, the valve is in a fully closed configuration, obstructing vapor passage 5. The openings 25a, 25b of the extension piece 24 are namely not aligned with the openings 26a, 26b of the hinge piece 17b and the opening 27 (not visible) of the closing wall is not aligned with the proximal end 9a of the vapor removal channel 9.

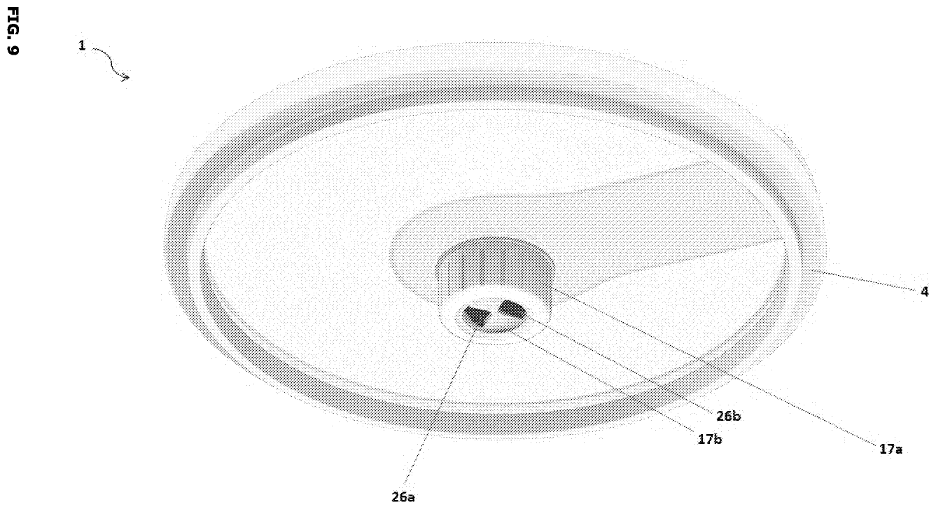

FIG. 9 shows a bottom view of a pot lid 1 according to an embodiment of the present invention wherein the valve comprises an extension piece (not visible) and the cap 17a comprises a hinge piece 17b with openings 26a, 26b. The openings 26a, 26b in the hinge piece 17b are aligned with the openings in the extension piece and vapor passage is made possible.

FIG. 10 shows a bottom view of the valve, the hinge piece of the cap 17b and the housing 16 of the vapor removal channel 9 of a pot lid according to an embodiment of the present invention in a fully open (A), a half-open (B), and a closed (C) configuration. In Figure A, the openings 26a, 26b in the hinge piece 17b are aligned with the openings 25a, 25b in the extension piece 24 and the opening 27 in the closing wall 12 is aligned with the vapor removal channel 9. In Figure B, the openings 26a, 26b in the hinge piece 17b are partially aligned with the openings 25a, 25b in the extension piece 24 and the opening 27 in the closing wall 12 is partially aligned with the vapor removal channel 9. In Figure C, the openings in the hinge piece 17b are not aligned with the openings 25a, 25b in the extension piece 24 and the opening 27 in the closing wall 12 is not aligned with the vapor removal channel 9.

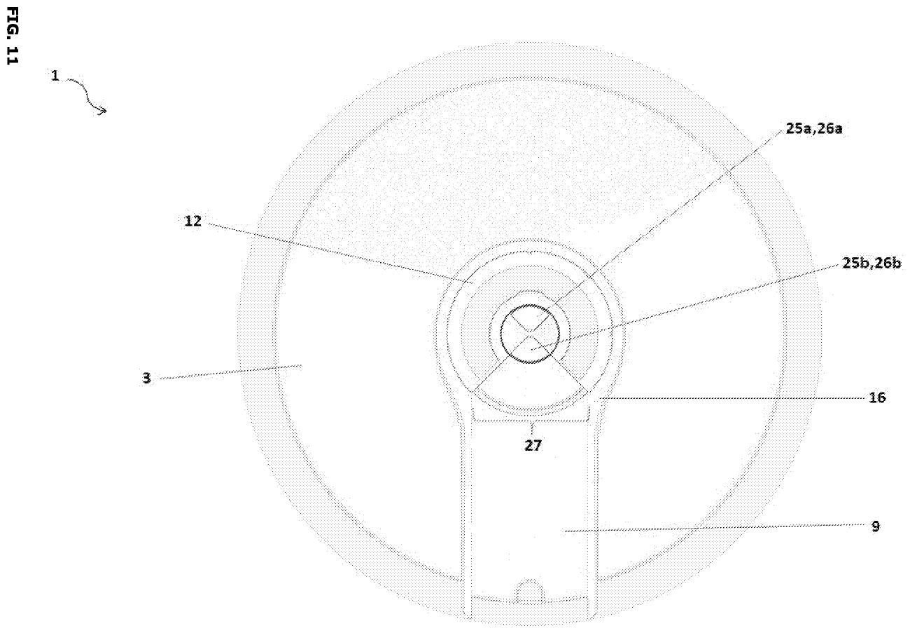

FIG. 11 shows a bottom view of a pot lid according to an embodiment of the present invention wherein the valve is in an open configuration. The openings 26a, 26b in the hinge piece 17b are aligned with the openings 25a, 25b in the extension piece 24 and the opening 27 in the closing wall 12 is aligned with the vapor removal channel 9.

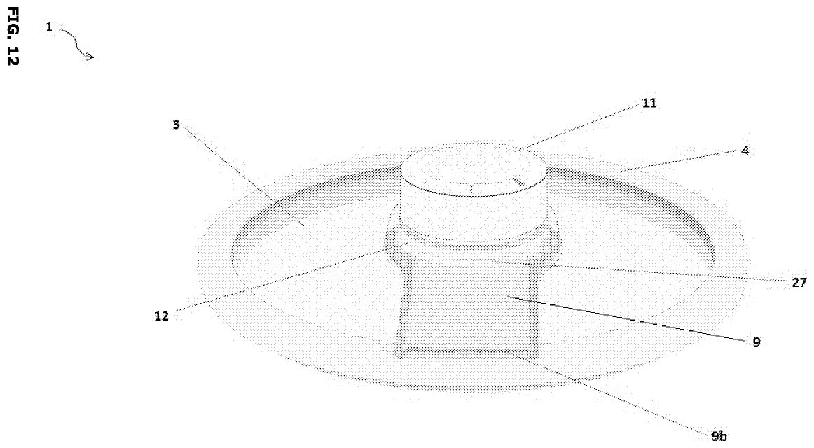

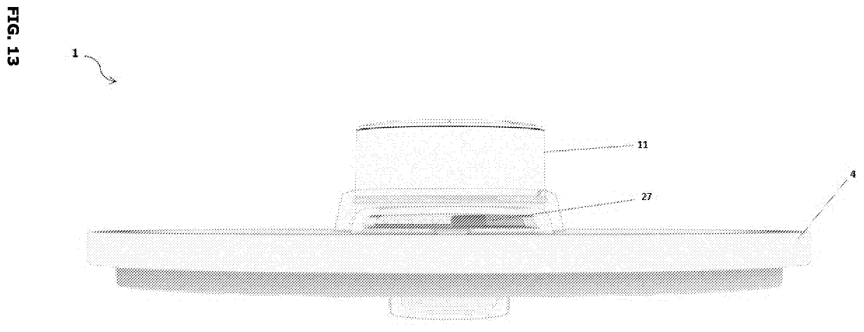

FIGS. 12 and 13 show a front view of a pot lid according to an embodiment of the present invention wherein the valve is in a half-open configuration. The opening 27 in the closing wall 12 is partially aligned with the vapor removal channel 9, so that a partial vapor passage is possible between the pot volume and the ambient volume. The vapor leaves the cooking pot via the distal end of the vapor removal channel 9b.

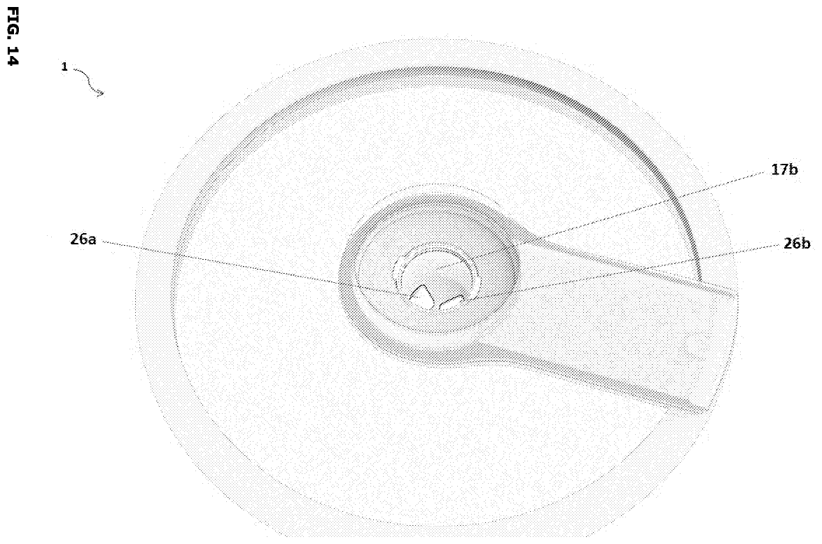

FIG. 14 shows a top view of a pot lid according to an embodiment of the present invention with the valve removed and wherein the hinge piece 17b with openings 26a, 26b is visible.

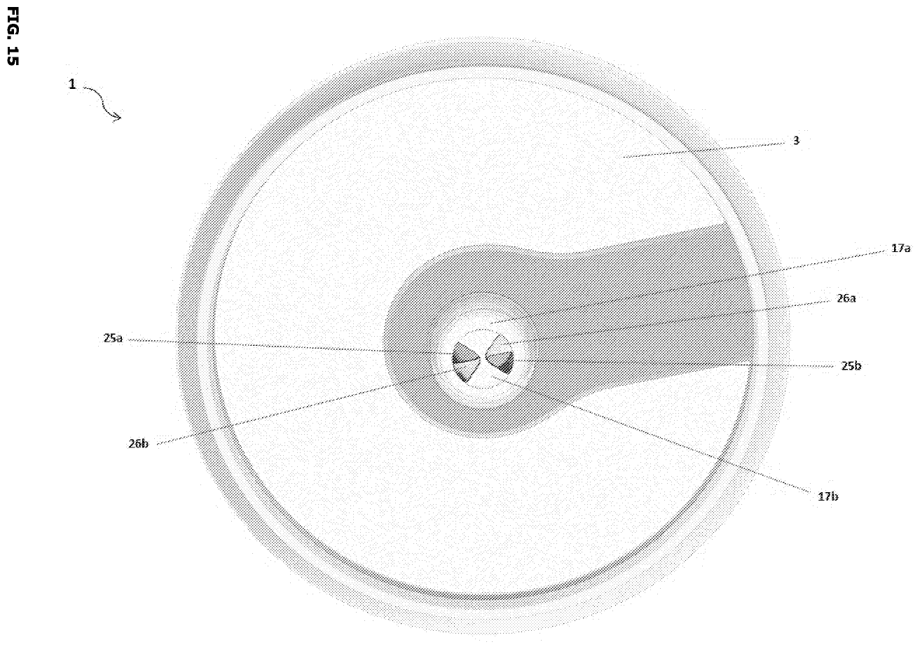

FIG. 15 shows a bottom view of a pot lid according to an embodiment of the present invention with the hinge piece with openings visible. The openings 26a, 26b in the hinge piece 17b are partially aligned with the openings 25a, 25b in the extension piece.

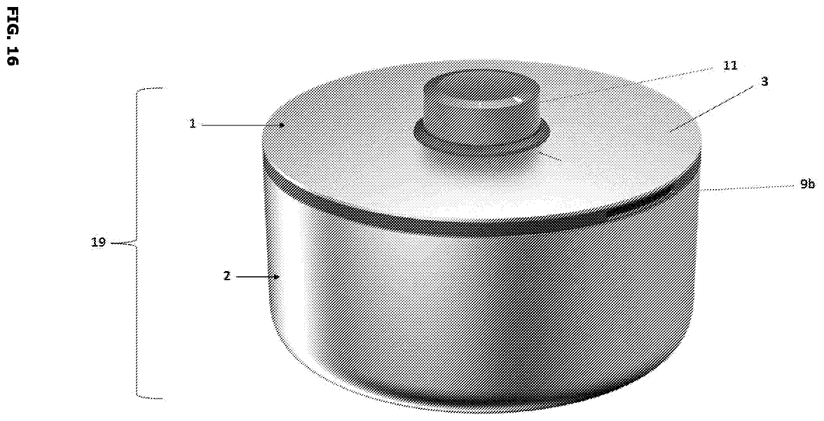

FIG. 16 shows a perspective side view of a cooking assembly 19 according to an embodiment of the present invention wherein the vapor removal channel 9 is located on the underside of the cover plate 3 of the pot lid 1. Only the distal end of the vapor removal channel 9b is visible in the figure.

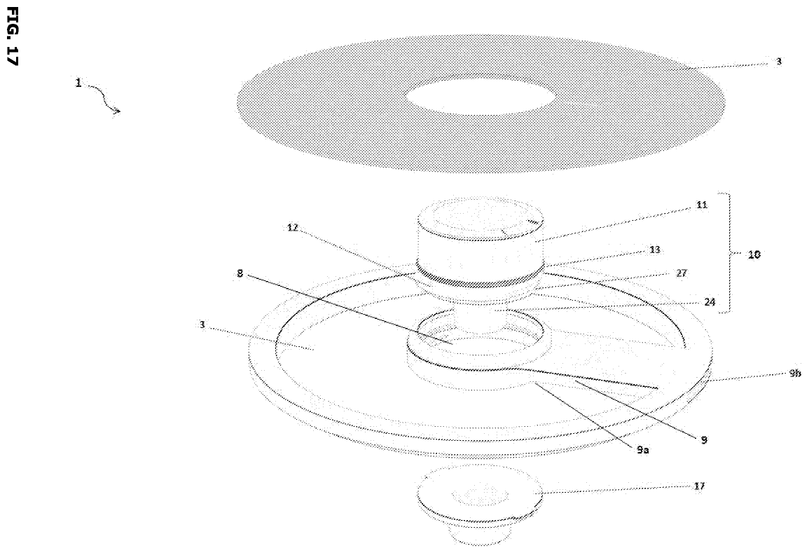

FIG. 17 shows a perspective side view of a pot lid 1 according to an embodiment of the present invention wherein the vapor removal channel 9 is located on the underside of the cover plate 3 of the pot lid 1. The valve comprises an additional extension piece 24. The extension piece 24 is part of the valve and is located under the closing wall 12, wherein the closing wall 12 is located at the level of the opening at the proximal end 9a of the vapor removal channel and wherein the extension piece 24 is located under this opening, in line with the vapor passage opening 8, under the plane of the cover plate. The extension piece 24 is provided with two openings (not visible) on the underside, which, when aligned with the openings (not visible) in the underside of the cap 17, allows vapor passage between the pot volume and the ambient volume. The cap 17 clicks into place on the extension piece 24 of the valve at the level of the vapor passage opening 8 by means of a bayonet coupling. The cap 17 is provided with openings (not visible) that may or may not align with the openings (not visible) in the extension piece. By regulating the valve 10 (for example by turning or pressing it), the flow rate will be regulated both by changing the position of the closing wall 12 and the openings in the extension piece.

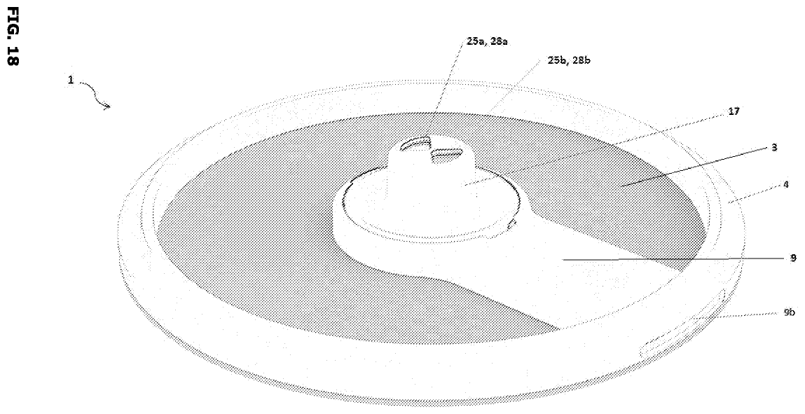

FIG. 18 shows a perspective side view of a pot lid 1 according to an embodiment of the present invention as described in FIG. 17, wherein the vapor removal channel 9 is located on the underside of the cover plate 3 of the pot lid. In this figure, the pot lid 1 is upside down (with the top downwards). The cap 17 clicks into place on the extension piece 24 of the valve at the level of the vapor passage opening 8 by means of a bayonet coupling. The cap 17 is provided with openings 28a, 28b which may or may not align with the openings 25a, 25b in the extension piece.

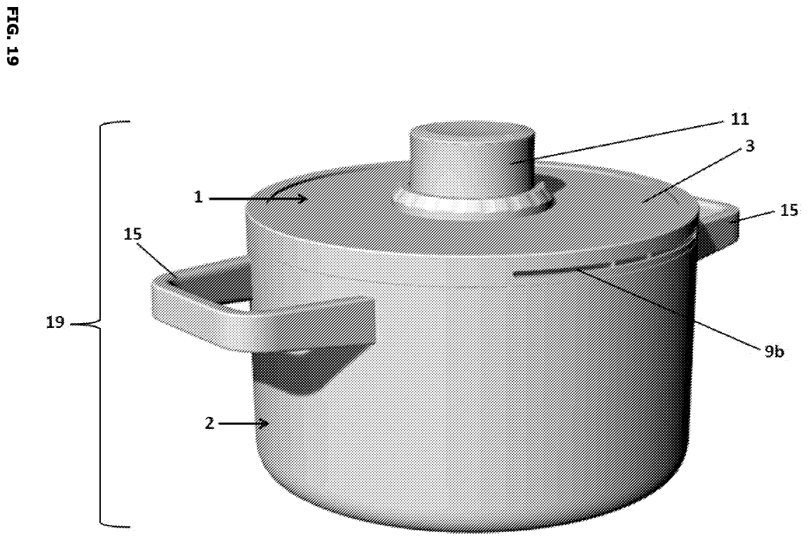

FIG. 19 shows a side view of a cooking assembly 19 according to an embodiment of the present invention wherein the vapor removal channel 9 is located on the underside of the cover plate 3 of the pot lid 1. Only the distal end of the vapor removal channel 9b is visible in the figure.

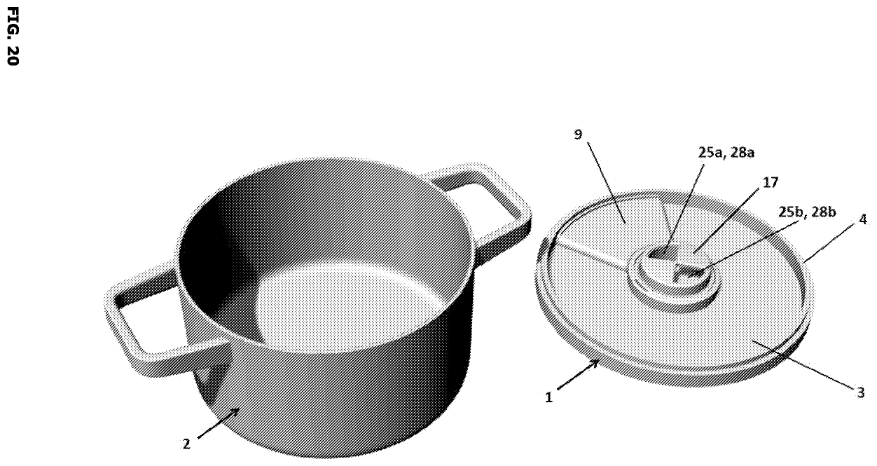

FIG. 20 shows a cooking assembly 19 according to an embodiment of the present invention wherein the vapor removal channel 9 is located on the underside of the cover plate 3 of the pot lid 1. The underside of the pot lid 1 is visible in FIG. 20. The cap 17 clicks into place on the extension piece 24 of the valve at the level of the vapor passage opening. The cap 17 is provided with openings 28a, 28b which may or may not align with the openings 25a, 25b in the extension piece.

The numbered elements in the figures are:
1. Pot lid
2. Cooking pot
3. Cover plate
4. Lid edge
5. Vapor passage
6. Pot volume
7. Ambient volume
8. Vapor passage opening
9. Vapor removal channel
9a. Proximal end of vapor removal channel
9b. Distal end of vapor removal channel
10. Valve
11. Rotary knob of the valve
12. Closing wall of the valve
13. Sealing ring
14. Projection of the valve
15. Handle
16. Vapor removal channel housing
17. or 17a. Cap at the vapor passage opening
17b. Hinge piece of the cap
18. Opening in the cap
19. Cooking assembly
20. Cooking unit
21. Vapor exhaust
22. Marking
23. Silicone rim of the pot lid
24. Valve extension piece
25. Openings in the valve extension piece (a, b)
26. Openings in the hinge piece of the cap (a, b)
27. Opening in the closing wall
28. Openings in the cap (a, b)

1. A pot lid for a cooking pot, wherein the pot lid comprises a cover plate and a lid edge and is provided with a vapor passage, wherein the vapor passage makes a fluid connection between a pot volume and an ambient volume, wherein the vapor passage is formed by a vapor passage opening in the cover plate of the pot lid and a vapor removal channel, wherein the vapor removal channel extends to the lid edge for discharging vapor to the lid edge and wherein the vapor removal channel is surrounded by a housing.

2. The pot lid for the cooking pot according to claim 1, wherein the pot lid is further provided with a valve for regulating a flow rate of the vapor passage through the vapor removal channel.

3. The pot lid for a the cooking pot according to claim 1, wherein the vapor removal channel is raised above a surface of the cover plate or wherein the vapor removal channel is located under the cover plate.

4. The pot lid for a the cooking pot according to claim 2, wherein the valve is rotatably connected to the housing of the vapor removal channel.

5. The pot lid for the cooking pot according to claim 1, wherein the vapor passage is further formed by a cap with an opening, wherein the cap is located on the an underside of the cover plate and at the a level of the vapor passage opening, for channeling of the vapor through the vapor passage opening.

6. The pot lid for the cooking pot according to claim 5, wherein the cap further comprises a hinge piece.

7. The pot lid for the cooking pot according to claim 2, wherein the valve comprises a rotary knob, push-button, adjustment lever or lever and a closing wall.

8. The pot lid for a the cooking pot according to claim 2, wherein the valve further comprises an extension piece.

9. The pot lid for the cooking pot according to claim 8, wherein the extension piece comprises one or more closable openings for regulating the flow rate of the vapor passage through the vapor removal channel.

10. The pot lid for the cooking pot according to claim 7, wherein the rotary knob, the push-button, the adjustment lever or the lever is adjustable in discrete steps or in a continuous manner.

11. The pot lid for the cooking pot according to claim 7, wherein the closing wall comprises a partial cylindrical shell.

12. The pot lid for the cooking pot according to claim 1, wherein the lid edge comprises a rubber clamp, for connection to the cooking pot.

13. The pot lid for a the cooking pot according to claim 1, wherein a distal end of the vapor removal channel extends in a downward direction to direct the vapor passage towards the cooking pot.

14. The pot lid for the cooking pot according to claim 1, wherein the pot lid comprises two handles, wherein the two handles extend diametrically, and wherein the vapor removal channel extends along a transverse direction, transverse to a diametrical direction of the two handles.

15. A cooking assembly comprising the pot lid according to claim 1 and a cooking pot.
